(19) United States
(12) Patent Application Publication
(10) Pub. No.: US 2009/0269534 A1
(43) Pub. Date: Oct. 29, 2009

(54) Adhesive tape

(76) Inventor: Michael Montiforte, Tarzana, CA (US)

Correspondence Address: LITMAN LAW OFFICES, LTD., POST OFFICE BOX 15035, CRYSTAL CITY STATION, ARLINGTON, VA, 22215-0035, US

(21) Appl. No.: 12/379,245

(22) Filed: Feb. 17, 2009

Related U.S. Application Data
(60) Provisional application No. 61/047,134, filed on Apr. 23, 2008.

(51) Int. Cl. B32B 7/06

(52) U.S. Cl. 428/41.8

(57) ABSTRACT

The adhesive tape is a multi-layer, pressure-sensitive adhesive tape having two different adhesive surfaces, one of which has a greater tack than the other. The adhesive tape includes a first backing layer having opposed 5 first and second surfaces, with a first adhesive coating the first and second surfaces thereof. The first adhesive has a first tack associated therewith. A second backing layer is further provided, with the second backing layer having opposed first and second surfaces. The first surface thereof is secured to the second surface of the first backing layer by the first adhesive, 1 o which is sandwiched therebetween. A second adhesive coats the second surface of the second backing layer, with the second adhesive having a second tack associated therewith. The first tack is greater than the second tack. A release strip is further provided, with the release strip releasably covering the first surface of the first backing layer.

### CROSS-REFERENCE TO RELATED APPLICATION

This application claims the benefit of U.S. Provisional Patent Application Ser. No. 61/047,134, filed Apr. 23, 2008.

### BACKGROUND OF THE INVENTION

1. Field of the Invention

The present invention relates to temporary fasteners, and particularly to an adhesive tape that provides a pressure-sensitive adhesive tape having two adhesive surfaces, one of which has a greater tack than the other.

2. Description of the Related Art

In today's entertainment industry, a substantial amount of television and movie footage is shot on location, rather than in the studio. External scenes are shot outdoors, and interior scenes are generally shot in rented facilities, and on both public and private properties. Quite often sets are temporary, covering the existing walls, floors, or the existing natural background with temporary flooring, wall boards or covers, temporary signage or pictures, fake storefronts, etc.

Since shooting on location is expensive, many sets are only needed temporarily, frequently for less than one or two weeks, and even less than one day. Consequently, it is only necessary to have the sets in place for a short period. Further, it is desirable to remove the sets without damaging existing walls, storefronts or the like. If the leased or rented property is damaged, it requires time, labor (often at union rates), and material costs to effectuate repairs, or monetary compensation to the owner of the property.

Many set designers, equipment managers, laborers, and others involved in location shooting use a strong adhesive tape to hold props, signage, or set backgrounds in place. Nevertheless, strong adhesive cannot be applied directly to the underlying surface, because a strong adhesive tape will strip or mar hardwood finish from floors, paint from walls or glass storefronts, etc. Consequently, it becomes necessary to put down some kind of easily removable cover material over the underlying surface before adhering the strong adhesive tape, a process that requires twice the time, both for installation and removal. Consequently, there is a need for a fastener that will strongly adhere to the article to be supported and that will temporarily fasten to the underlying support surface, but can be easily removed without damaging the underlying support surface.

Thus, an adhesive tape solving the aforementioned problems is desired.

### SUMMARY OF THE INVENTION

The adhesive tape is a double-sided pressure-sensitive adhesive tape, providing a tape having two different adhesive surfaces, one of which has a greater tack than the other. The adhesive tape may be a multilayer laminate. The adhesive tape includes a first backing or carrier layer having opposed first and second surfaces, with a first adhesive coating the first and second surfaces thereof. The first adhesive has a first tack associated therewith.

A second backing layer may be further provided, with the second backing layer having opposed first and second surfaces. The first surface thereof is secured to the second surface of the first backing layer by the first adhesive, which is sandwiched therebetween. A second adhesive coats the second surface of the second backing layer, with the second adhesive having a second tack associated therewith. The first tack is greater than the second tack. Preferably, a release strip is further provided, with the release strip releasably covering the first surface of the first backing layer. Alternatively, the adhesive tape may have a single backing coated with a strong tack adhesive on one side and a moderate tack adhesive on the opposite side.

These and other features of the present invention will become readily apparent upon further review of the following specification and drawings.

### BRIEF DESCRIPTION OF THE DRAWINGS

FIG. 1A is a side view in section of a first embodiment of an adhesive tape according to the present invention.

FIG. 1B is an exploded side view in section of the adhesive tape of FIG. 1A.

FIG. 2 is a side view in section of an alternative embodiment of an adhesive tape according to the present invention.

FIG. 3 is a perspective view of the adhesive tape of FIG. 1A, shown formed as a roll.

Similar reference characters denote corresponding features consistently throughout the attached drawings.

### DETAILED DESCRIPTION OF THE PREFERRED EMBODIMENTS

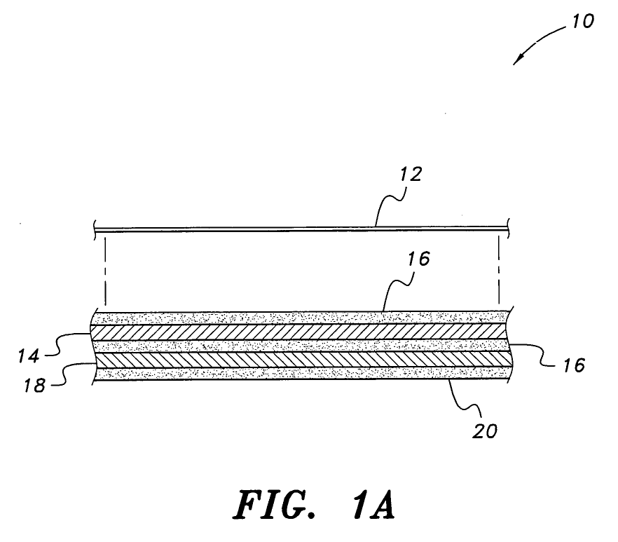

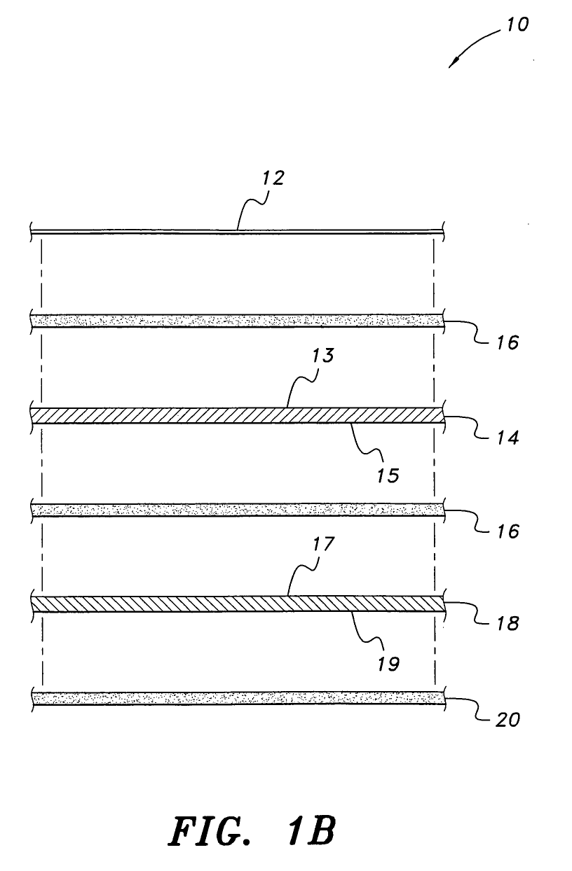

Now referring to FIGS. 1A and 1B, there is shown an adhesive tape 10, which is a multi-layer, pressure-sensitive adhesive tape, providing a tape having two different adhesive surfaces, one of which has a greater tack than the other. The adhesive tape 10 includes a first backing or carrier layer 14 having opposed first and second surfaces 13, 15, respectively, with a first adhesive 16 coating the first and second surfaces 13, 15 thereof. The first adhesive 16 has a first tack associated therewith. The first adhesive 16 may be coated onto the first and second surfaces 13, 15 through any suitable method of forming thin films.

The first backing layer 14 may be formed from any suitable tape backing material, such as cloth. One example of a cloth-based pressure-sensitive tape having a relatively high tack adhesive formed thereon is Shurtape®DF 545, which is a double-sided adhesive tape manufactured by Shurtape Technologies, LLC of Hickory, N.C., having a strong tack on both sides of the tape. Shurtape DF 545, e.g., has an adhesion to stainless steel of about 45 oz/in (4.93 N/10 mm) as measured by ASTM D 3330 (the standard test measure of peel adhesion for pressure-sensitive tape). Alternatively, the first backing layer 14 may be formed from foam. An example of a foam-based pressure-sensitive tape is 3M® Double Coated Urethane Foam Tape 4056, manufactured by the 3M Company of St. Paul, Minn. It should be understood that first backing layer 14 may be formed from any suitable material, such as foam, urethane, vinyl, polyethylene, cloth, urethane foam, polyethylene foam or any other suitable material.

A second backing layer 18 is further provided, with the second backing layer 18 having opposed first and second surfaces 17, 19, respectively. The first surface 17 is secured to the second surface 15 of the first backing layer 14 by the first adhesive 16, which is sandwiched therebetween. A second adhesive 20 coats the second surface 19 of the second backing layer 18, with the second adhesive 20 having a second tack associated therewith, which may be described as a moderate tack. The first tack of first adhesive 16 is greater than the second tack of second adhesive 20.

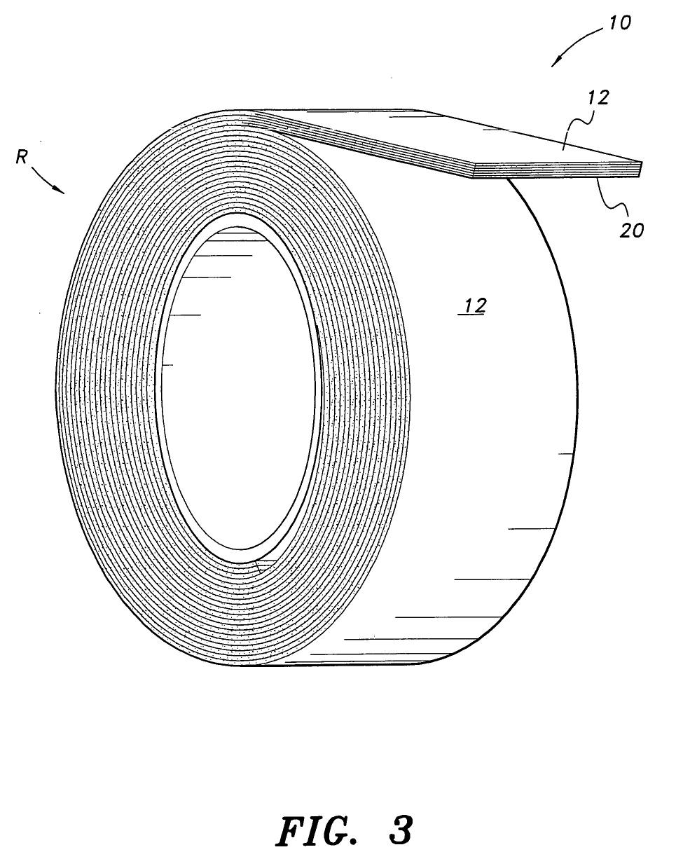

Second backing layer 18 may be formed from any suitable material, such as vinyl, urethane, polyethylene or the like. One example of a conventionally backed pressure-sensitive tape having a relatively low or medium range tack is Scotch-Blue Painter's Tape, manufactured by the 3M Company of St. Paul, Minn. The tack of painter's tape is such that the tape may be pulled or removed from the surface it is adhered to without marring any underlying wall paint, hardwood finish, or the like, at least if the painter's tape is removed before the adhesive has had sufficient time to permanently bond to the underlying surface, a period that may vary between a couple of days to a couple of weeks, depending upon the brand of adhesive. Painters tape typically has a tack that may be described as low to medium, and a peel adhesion that may vary between 19 oz/in and 40 oz/in as measured by ASTM D 3330. Preferably, as shown, a release strip 12 is further provided, with the release strip 12 releasably covering the first surface 13 of the first backing layer 14, with the release strip 12 covering the first adhesive 16 formed thereon. Release strip 12 may be formed from paper or the like. As shown in FIG. 3, the adhesive tape 10 may be provided as a roll R, with desired lengths of adhesive tape 10 being unrolled and cut therefrom.

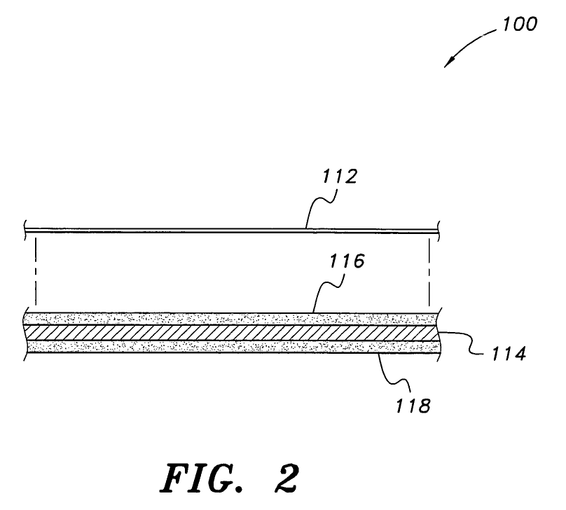

In the alternative embodiment of FIG. 2, adhesive tape 100 includes a backing or carrier layer 114 having opposed first and second surfaces, with a first adhesive 116 coating the first surface thereof, and a second adhesive 118 coating the second surfaces thereof, as shown. The first adhesive 116 has a first tack associated therewith and the second adhesive 118 has a second tack associated therewith, with the first tack of first adhesive 116 being greater than the second tack of second adhesive 118. The first and second adhesives 116, 118 may be coated onto the first and second surfaces of backing layer 114 through any suitable method of forming thin films.

The backing layer 114 may be formed from any suitable tape backing material, such as, for example, cloth, foam, urethane, vinyl, polyethylene, urethane foam, polyethylene foam or any other suitable material. As in the embodiment of FIGS. 1A and 1B, a release strip 112 is preferably provided. Release strip 112 may be formed from paper or the like. Similarly, the adhesive tape 100 may be provided as a roll, with desired lengths of adhesive tape 100 being unrolled and cut therefrom.

One example of usage of adhesive tape 10 is in the adherence of a temporary vinyl floor panel or the like. A suitable length of adhesive tape 10 would be unrolled and cut from roll R and the second adhesive 20 of second backing layer 18 would be placed on the permanent floor. Then, the release strip 12 is removed from the upper backing layer 14 and the temporary floor panel may be secured thereto via first adhesive 16. This allows the temporary floor panel to be easily removed and replaced, with the relatively low tack second adhesive 20 being easily removed from the permanent floor. The adhesive tape 10 can be similarly used for attachment of temporary signage, set props or the like, for example.

It is to be understood that the present invention is not limited to the embodiments described above, but encompasses any and all embodiments within the scope of the following claims.

I claim:

1. An adhesive tape, comprising:
a first backing having opposed first and second surfaces, the first backing having an adhesive layer made from a first adhesive coating both the first and second surfaces, the first adhesive having a first tack strength;
a second backing layer having opposed first and second surfaces, the first surface thereof being adhesively attached to the second surface of the first backing, the second backing having an adhesive layer made from a second adhesive coating the second surface thereof, the second adhesive having a second tack strength associated therewith, the first tack strength lo being greater than the second tack strength.

2. The adhesive tape as recited in claim 1, further comprising a release strip releasably secured to the first surface of said first backing, the first adhesive being sandwiched therebetween.

3. The adhesive tape as recited in claim 2, wherein said release strip is formed from paper.

4. The adhesive tape as recited in claim 2, wherein said first backing is formed from cloth.

5. The adhesive tape as recited in claim 2, wherein said first backing is formed from foam.

6. An adhesive tape, comprising:
a backing having opposed first and second surfaces;
an adhesive layer made from a first adhesive coating the first surface;
an adhesive layer made from a second adhesive coating the second surface, the first adhesive having a tack strength greater than the second adhesive; and
a release strip releasably secured to the first surface of the backing, the layer of first adhesive being sandwiched therebetween.

7. The adhesive tape as recited in claim 6, wherein said release strip is formed from paper.

8. The adhesive tape as recited in claim 6, wherein said backing is formed from cloth.

9. The adhesive tape as recited in claim 6, wherein said backing is formed from foam.
